(19) United States
(12) Patent Application Publication
(10) Pub. No.: US 2009/0183407 A1
(43) Pub. Date: Jul. 23, 2009

(54) Magnetically mounted reusable display sign

(76) Inventor: Anan Bidawid, Palmdale, CA (US)

Correspondence Address: ANAN BIDAWID, PO BOX 900400, PALMDALE, CA, 93590, US

(21) Appl. No.: 12/319,960

(22) Filed: Jan. 14, 2009

Related U.S. Application Data
(60) Provisional application No. 61/010,928, filed on Jan. 14, 2008.

(51) Int. Cl. G09F 15/00

(52) U.S. Cl. 40/606.01

(57) ABSTRACT

This invention is a portable display sign with a magnetically-mounted frame and a removable/reusable display panel. It is intended for use by merchants, trades people, educators and other organizations as an advertising and/or informational tool. Two magnetic foot assemblies provide stability and strong holding capability on any horizontal steel surface. The display panel is made of 4 mm coroplastic, which is temperature resistant. The frame is rigid and composed of PVC foam. The overall size of the sign is compact (66×48×2 cm) and lightweight, so it can be conveniently transported, shipped and stored. The overall design of the sign and its components are economical to manufacture and reusable.

### CROSS-REFERENCE TO RELATED APPLICATIONS

This application claims the benefit of priority to Provisional Patent No. 61/010,928, filed Jan. 14, 2008.

### FEDERALLY SPONSORED RESEARCH

Not Applicable

### PARTIES TO A JOINT RESEARCH AGREEMENT

Not Applicable

### SEQUENCE LISTING OR PROGRAM

Not Applicable

### BACKGROUND OF INVENTION

This application relates to a portable display sign; particularly to a sign with (1) a magnetically-mounted frame and (2) a removable and reusable display panel. It is designed to address display signs with attachment methods that are cumbersome to affix and remove, can mar surfaces and are not easily transported.

This application claims the benefit of priority to Provisional Patent No. 61/010,928, filed Jan. 14, 2008.

### BRIEF SUMMARY OF INVENTION

The objective of this invention is to provide a display sign that is easily removable, reusable, and transportable which can be used by, but not limited to, vendors, trades people and educators. To this end, this invention provides a portable, lightweight sign comprised of (1) a frame (made of a rigid material), which is magnetically-mounted to any horizontal steel surface via (2) two magnetic foot assemblies (with protective coverings), and (3) a removable/reusable display panel.

### DRAWINGS

### Brief Listing of Drawings

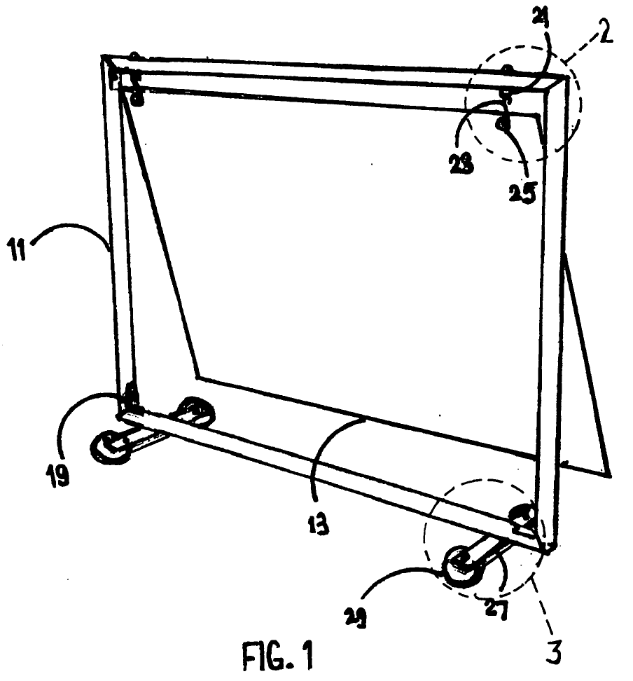

FIG. 1 shows a perspective view of all of the sign components.

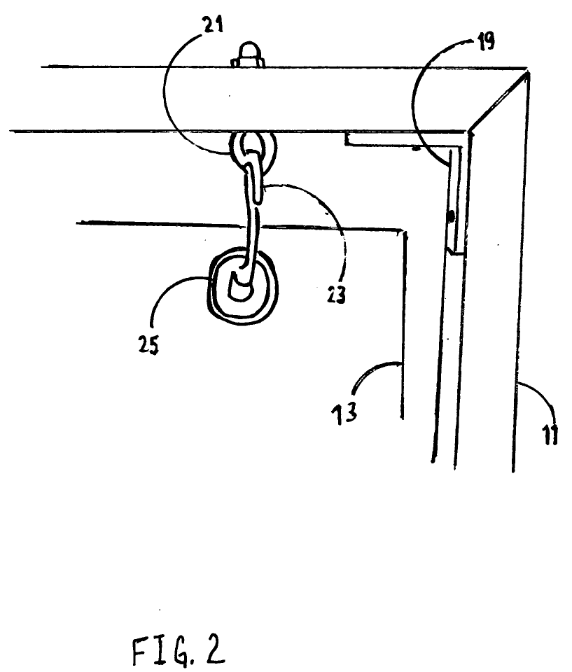

FIG. 2 shows an enlarged view of one of the top corner assemblies.

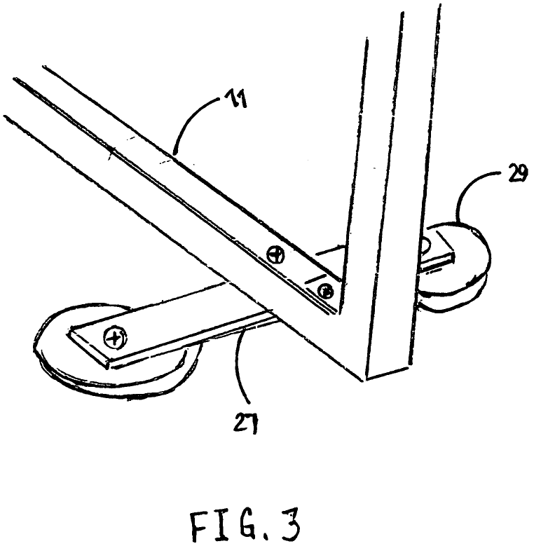

FIG. 3 shows an enlarged view of one of the bottom magnetic foot assemblies.

### DETAILED DESCRIPTION OF THE INVENTION

This invention consists of a removable and reusable magnetically-mounted sign that can be used on any horizontal steel surface. Its elements include (1) a rigid frame comprised of PVC foam, (2) a removable and reusable display panel composed of temperature-resistant coroplastic, and (3) two magnetic foot assemblies. It is designed to be easily transported and used by, but not limited to, vendors, trades people and educators.

FIG. 1 shows the three major components of the sign: the frame 11, the display panel 13 and two magnetic-foot assemblies 31. These components are detailed below.

The frame 11 is composed of expanded (Sintra) PVC foam. (The frame could also be constructed of other materials such as aluminum, plastic or wood.) The overall dimensions of the frame are 66×48×2 cm. The frame sides are joined by L-brackets, 19. Two eyebolts 21 with “S” hooks 23 are permanently affixed to the frame.

The display panel 13 is composed of temperature-resistant coroplastic, 4 mm thick. The top of the panel has two metal grommet-reinforced holes 25 drilled in alignment with the eyebolts 21 and “S” hooks 23. The holes 25, eyebolts 21 and “S” hooks 23, permit easy removal of the panel from the frame as well as reuse of the panel.

There are two magnetic-foot assemblies 31 attached perpendicularly to the bottom of the frame. Each foot assembly consists of one aluminum strip 27 and two nickel-finished magnets 29

FIG. 2 is an enlarged view of one of the top corners of the sign. It details: one of the four L-brackets 19 that join the sides of the frame 11; and, one of the two eyebolts 21, one of the two “S” hooks 23, and one of the two metal grommet-reinforced holes 25 (all of which are permanently affixed) that permit the attachment and removal of the display panel 13 from the frame 11.

FIG. 3 is an enlarged detail of one of the two magnetic-foot assemblies 31. Each foot assembly is affixed perpendicularly to the bottom of the frame and consists of one 3×15 cm aluminum strip 27, and two nickel-finished magnets 29, each with a holding value of 35#. All magnets have a protective covering to minimize friction to applied surfaces.

I claim:

1. An article of manufacture for displaying information comprised essentially of: a frame, a display surface, and at least two foot assemblies.

2. The article of manufacture of claim 1 wherein said foot assemblies function as connecting members to a secondary surface.
